(19) United States
(12) Patent Application Publication
(10) Pub. No.: US 2017/0228348 A1
(43) Pub. Date: Aug. 10, 2017

(54) ONLINE COMMUNITY BRAGGING WALL

(71) Applicant: Bryan KOONTZ, Austin, TX (US)

(72) Inventor: Bryan KOONTZ, Austin, TX (US)

(21) Appl. No.: 15/017,029

(22) Filed: Feb. 5, 2016

(51) Int. Cl. G06F 17/21; H04L 29/08

(52) U.S. Cl. CPC G06F 17/212; H04L 67/02; H04L 67/10

(57) ABSTRACT

Computer architecture and methods for displaying and arranging images are disclosed. The computer architecture includes terminals and a central server coupled to the terminals. The terminals display images including personal images and non-personal images in accordance with a layout, receive brag indicators for personal images displayed by that terminal, receive nice indicators for non-personal images displayed by that terminal, and transmit brag indicators and nice indicators. The central server receives the brag indicators and the nice indicators associated with the images from the terminals, generates the layout based on the received brag indicators and the received nice indicators such that images are emphasized based on a number of nice indicators associated with the images, and transmit the layout to the plurality of terminals for display of at least a portion of the images. Also disclosed are computer architecture and methods for organizing stories and creating/managing web pages depicting those stories.

### FIELD OF THE INVENTION

The present invention relates to online sharing of sporting (e.g., hunting, fishing, and general outdoor) related photographs.

### BACKGROUND OF THE INVENTION

Sporting photographs are often shared at conventions with individual bragging walls. Sportsmen (e.g., hunters, anglers, etc.) will manually post pictures to brag about their sporting endeavors. There exists a need for systems to provide reliable functionality for bragging walls to be implemented in online communities.

### SUMMARY OF THE INVENTION

Aspects of the invention are embodied in computer architecture and methods for displaying and arranging images. The computer architecture includes terminals and a central server coupled to the terminals. The terminals display images including personal images and non-personal images in accordance with a layout, receive brag indicators for personal images displayed by that terminal, receive nice indicators for non-personal images displayed by that terminal, and transmit brag indicators and nice indicators. The central server receives the brag indicators and the nice indicators associated with the images from the terminals, generates the layout based on the received brag indicators and the received nice indicators such that images are emphasized based on a number of nice indicators associated with the images, and transmit the layout to the plurality of terminals for display of at least a portion of the images. Other aspects of the invention are embodied in computer architecture and methods for organizing stories and creating/managing web pages depicting those stories.

### BRIEF DESCRIPTION OF THE DRAWINGS

The invention is best understood from the following detailed description when read in connection with the accompanying drawings, with like elements having the same reference numerals. When a plurality of similar elements is present, a single reference numeral may be assigned to the plurality of similar elements with a small letter designation referring to specific elements. When referring to elements collectively or to a non-specific one or more of the elements, the small letter designation may be dropped. Included in the drawings are the following figures:

FIG. 1 is a diagram of a system according to aspects of the invention;

FIG. 2A is a block diagram depicting a personal board in accordance with aspects of the invention;

FIG. 2B is a block diagram depicting a displayed image according to aspects of the invention;

FIG. 3A is a block diagram depicting a community board according to aspects of the invention;

FIG. 3B is a block diagram depicted a displayed image on a community board in accordance with aspects of the invention;

FIG. 4 is a block diagram depicting an updated community board according to aspects of the invention;

FIG. 5 is a flowchart of steps for a method of providing and updating a community board in accordance with aspects of the invention;

FIGS. 6 and 7 are examples of story pages in accordance with aspects of the invention; and

FIG. 8 is an example of an outfitter page with links to story pages according to aspects of the invention.

### DETAILED DESCRIPTION OF THE INVENTION

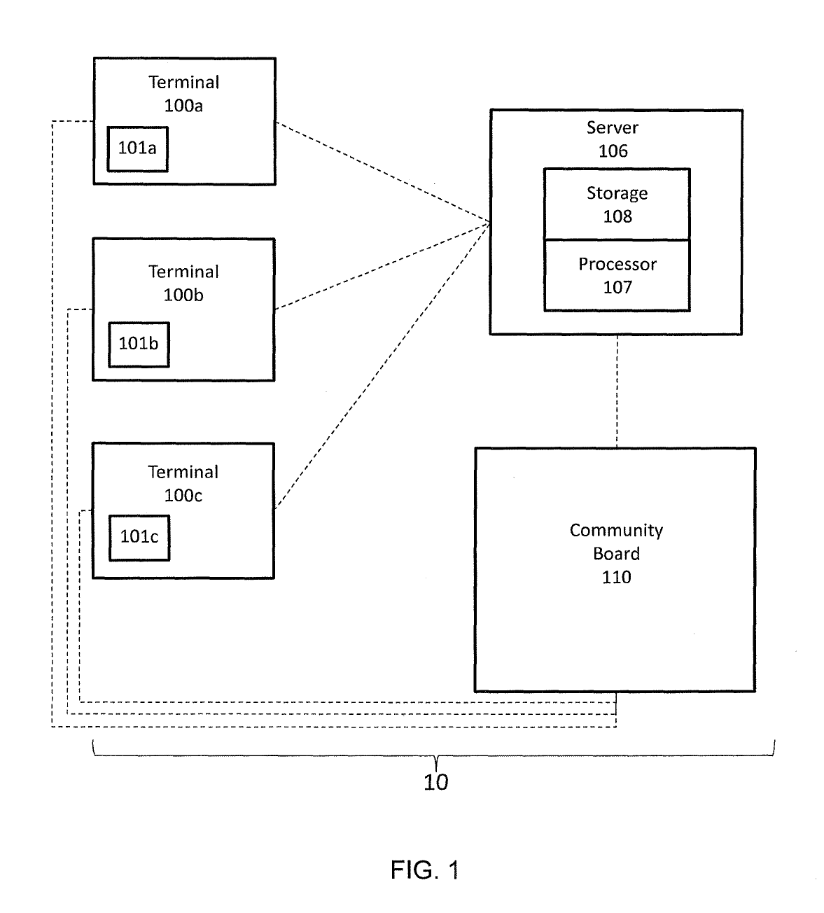

Referring to FIG. 1, a system 10 for operating an online community bragging wall is shown. Bragging walls are often used in the sporting (e.g., hunting, fishing, and other outdoor sporting) industry as a way to show a sportsman's achievements. Bragging walls often include a collage of photographs of a sportsman (hunter, angler, etc.) with various game that have been hunted, caught, or other achievements. The system 10 is developed to advantageously provide for an online bragging wall that is shared with a community and is dynamically updated based on the quality of the photographs as decided by the community. Additionally, system 10 may be used to demonstrate the suitability of businesses within the sporting industry, such as sporting (e.g., hunting) outfitters, to be able to depict exciting adventures to prospective customers. Although the invention is described with reference to hunting of animals, it is understood that the invention is applicable to other sporting industries, such as fishing, gaming, outdoor sports, etc. and/or other types of photographs (e.g., personal photographs) that the sportsman wants to brag about.

The system 10 includes a plurality of terminals (represented by terminals 100a, 100b, and 100c), and a server 106 with a storage medium 108 and a processor 107. The server 106 is configured to implement the online community bragging wall software/application. The terminals may be computers, smart phones, tablets, and/or any other devices capable of accessing the server 106 and displaying personal boards associated with individual users and the community board 110. Although three terminals 100 are depicted, it is contemplated that any number of terminals may be utilized with the system 10. The terminals 100 are coupled to the server 106 via a network such as the Internet (not shown). A user of a terminal 100 may upload images (e.g., personal images) to the terminal, display the images on a personal board 101, upload/send one or more of the images to the server 106 for use in a community board, transmit brag indicators and nice indicators to the server 106, display images on a community board, and/or receive data for generating the community board 110 from the server 106. Although the invention is described herein in relation to images, it is contemplated that videos, music files, software applications, and other forms of media may be utilized.

The server 106 includes a storage medium 108 for storing the images and other information associated with the photographs that are uploaded. The storage medium 108 may be a physical storage device located on the server 106 or an external or cloud based storage device. The server 106 facilitates communication between the terminals 100 and the community board 110. A processor 107 of the server 106 is configured to receive, update, generate and/or regenerate the layout for the images to be displayed on the community wall 110 as will be described below.

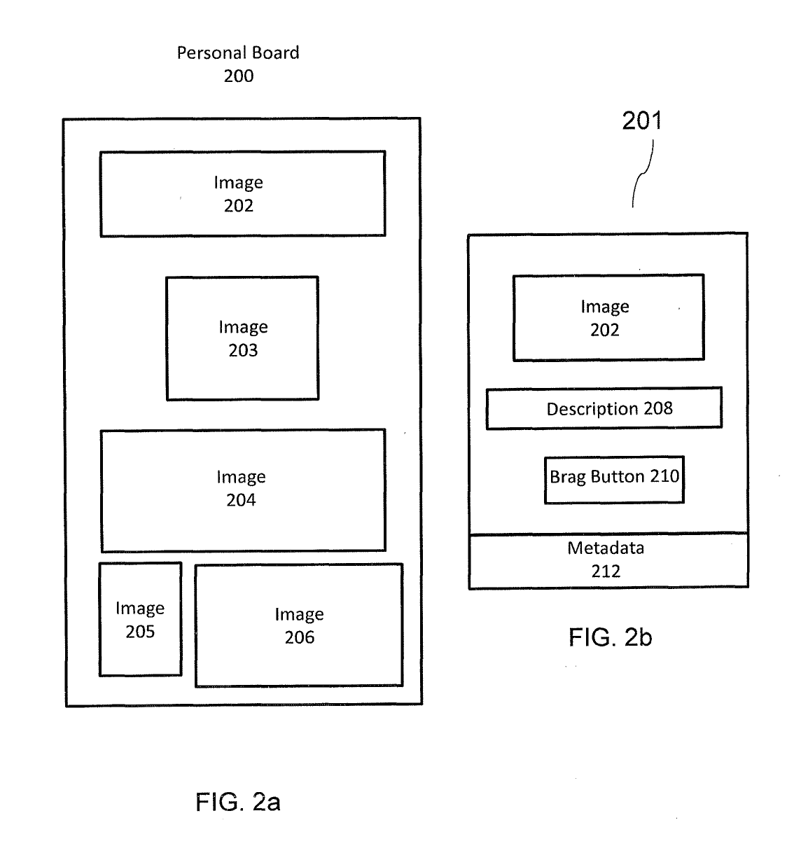

FIG. 2A is a block diagram depicting an example of a personal board 200. A personal board 200 is a board that is associated and maintained by a user and is capable of displaying personal images, such as images 202-206. FIG. 2B is a block diagram 201 representing data that may be associated with an image, such as image 202. The image 202 may be displayed with a description 208 associated with the image 202 that is provided by the user. Additionally, a brag button 210 is provided. When selected by the user, the brag button 210 functions to send a brag indicator for the image 202 to be included in the layout for a community board. When selected, the brag button 210 may also send a brag indicator for the image 202 to be included in a personal bragging wall, which would include and display all images that have been selected to be bragged by the user. Along with the description 208, additional metadata 212 may be associated with the image 202. The metadata may include GPS data, date and time of the image 202, people in the image 202, animal species data, name of an outfitter, etc. The image 202 may also include a nice button, the functionality of which is described below.

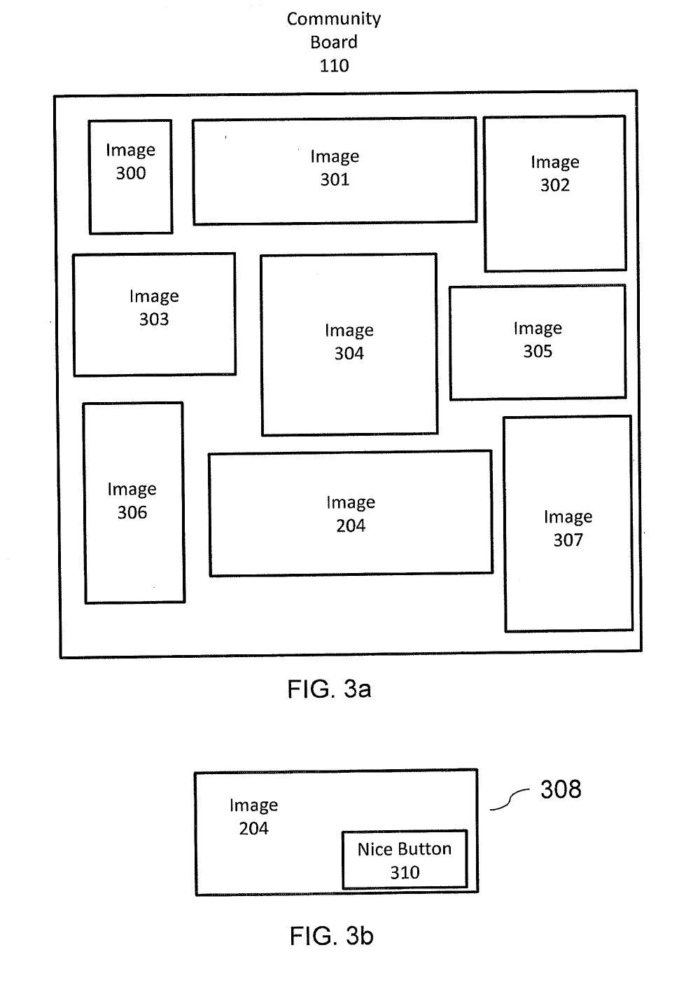

FIG. 3A is a diagram of a layout for a community board in accordance with aspects of the invention. The community board 110 is accessible and viewable from all users of the system 10. The community board 110 includes images (personal images to a user, and non-personal images, such as those uploaded by other users), such as images 300-307 and displays the images in a collage-like format. Users can access the community board 110 and view the images, as well as the data associated with the images. As depicted in FIG. 3B, each image, such as image 204, is provided with a nice button 310. Users viewing the community board 110 may select an image to “nice” by selecting the nice button 310 (alternative indications may be used, such as “oh yeah” or “like” etc.). By selecting the nice button 310, a nice indicator for the image is sent to the server 106, and may initiate a regenerated layout for the community board 110 based on a number of nices associated with the images. In an embodiment, the images on the community board 110 are arranged from top to bottom according to the number of nice indicators associated with each image in the manner described below.

Images may be provided to the community board 110 in various manners. In one example, the terminals 100 include browsers to display webpages created by the server 106 and sent to the terminals 100 for display. In accordance with this embodiment, a user uploads a personal image to the terminal 100 and then sends the image to the server 106. The server 106 receives the image and creates a personal webpage (e.g., personal board 101) using the received images. The server 106 then serves a webpage with the personal board 101 to the terminal 100 such that the terminal 100 displays the personal board 101 with the images. The user may then select an image from the personal board 101 to “brag” using a brag button, such as brag button 210. By using the brag button, the user is selecting which images the user wishes to be displayed on the community board 110. The brag button generates a brag indicator for the image, the brag indicator is then transmitted to the server 106, and the server 106 creates the community board 110 with the images that have received brag indicators. The processor 107 generates a layout for the images that have received brag indicators to be displayed on a community board. The server 106 then serves the community board 110 to be displayed on the terminals 100. When viewing the community board 110, a user may select an image displayed on the community board to “nice” using a nice button, such as nice button 310. Nice buttons may also be provided to users via a personal bragging wall, personal page, adventures wall, outfitter page, etc. The nice button generates a nice indicator, and the nice indicator is transmitted to the server 106. The received nice indicator changes the number of nice indicators associated with the images displayed on the community board 110, and the server 106, via the processor 107, regenerates the layout of the images (e.g., positioning of the images) on the community board 110 based on the number of nice indicators received for each image.

The server 106 may also associate an image on the community board 110 with a corresponding identical image on the user's personal board 101. For example, upon the user bragging and/or uploading an image on his or her personal board 101 to the community board 110 by way of actuating the brag button 210, the server 106 may associate the image on the personal board 101 with the corresponding image on the community board 106. In one embodiment, the server 106 associates the number of nice indicators given to a specific image on the community board 110 with the corresponding image on the personal board 101. In another embodiment, the server 106 further associates all the nice indicators provided to a specific image on any of public walls, e.g., community boards 110, adventure pages, outfitter pages, personal photo albums, etc., with the corresponding image on the personal board 101.

Alternatively, the terminals 100 may include a software application (an app) such that the terminals generate the personal boards 101 independently from the server 106. The generated personal boards 101 may be uploaded to the server 106 for storage on the memory storage 108. A user of the terminal 100 then selects an image from the personal board 101 to be displayed on the community board 110 by generating a brag indicator, e.g., via a brag button 210, for the image. The “bragged” image is then sent to the server 106. The processor 107 the generates a layout for the images that are to be displayed on the community board 110, and then generates the community board 110 for all “bragged” images. Once the community board 110 is generated, the server may arrange, via the processor 107, the images on the community board 110 based on a number of nice indicators associated with each image. The created community board 110 can then be accessed by the terminals 100 (e.g., transmitted from the server 106 to the terminals 100) and displayed on the terminals 100. A user viewing the community board 110 can select an image on the community board 110 to “nice”, e.g., via a nice button 310. This generates a nice indicator for the image, and the nice indicator is then transmitted to the server 106. The server 106, via the processor 107 can regenerate the layout for the images on the community board 110 based on the change in the number of nice indicators received for each image displayed on the community board. It is contemplated that a combination of terminals configured to display a webpage served from a server and terminals with a software app installed on the terminal may be utilized.

When a user selects to “brag” an image, the system may require the user to provide data associated with the image. Data can include metadata such as location of the image, species of the animal, time and day of the image, outfitter information associated with the image (e.g., if the hunt was sponsored by a particular outfitter), etc. Once the image is “bragged”, the image is accessible and viewable to other users via the community board 110, as well as still being accessible and viewable to users via the personal board 200, personal photo album, and/or personal bragging wall.

Once “bragged,” the image is included in the layout of the community board 110 for viewing by other users. The users may identify images that they believe should be highlighted to others and “nice” the image. As used herein, the term “nice” is used to describe a label of a button or other operation that can be performed by users of the system to generate a nice indicator, which indicate an image that they identify and believe should be highlighted to others. Other users can “nice” the image from either the community board 110 or the personal board 200, e.g., via nice buttons 310. It is contemplated that the user can “nice” an image from anywhere in the system that the image is displayed, such as personal bragging walls, adventure pages, outfitter pages, personal photo albums, etc. A user may “nice” the image because the user approves of the quality of the image, the animal depicted in the image, etc.

The community board 110 is configured to display the images that have received brag indicators in order of the number of nice indicators each image has received, from most to least, such that the images with the most “nices” will appear at the top of the community board. When an image receives a nice indicator, the server 106 via the processor 107 may regenerate the layout of the images if necessary in real time, at specified time intervals, etc. For example, as depicted in FIG. 3A, the user of personal board 200 “bragged” image 204 such that image 204 appears on the community board 110. If another user, either via the community board 110 or the personal board 200, “nices” the image, the image 204 may be repositioned on the community board 110.

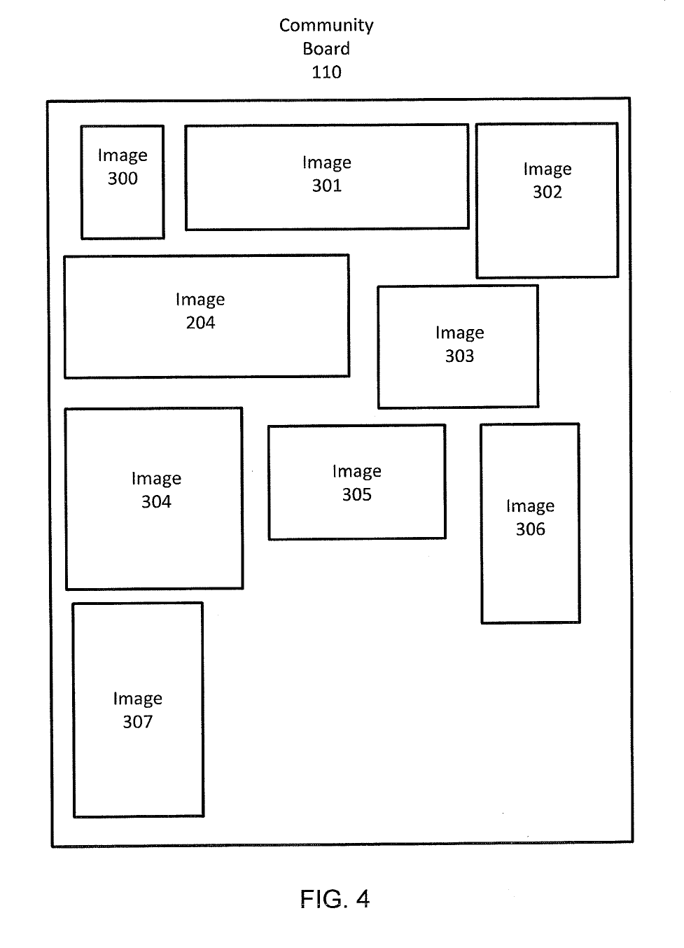

The repositioning is depicted in FIG. 4. In FIG. 4, the image 204 has received enough “vices” such that it is repositioned higher on the community board 110, and images 303-307 are moved down the community board 110. The repositioning may occur in real-time, and the repositioning may be visible to users as it happens. For example, the repositioning may appear to a user viewing the community wall 110 as a push, with the image 204 physically moving up the wall and “pushing” images 303-307 further down the wall. When an image receives a “nice” and/or is repositioned, the user that uploaded the image and bragged the image may receive a notification from the system that such actions have occurred.

In some examples users may be required to include data associated with a photograph (i.e., metadata) in order to “brag” it (e.g., to display it on the community wall 110), the system provides searching function for other users. For example, a user may select or limit the images that appear on their view of the community wall based on location, time and day, animal species, outfitter, and/or any other data associated with the images on the community wall. When a user performs such searching or limiting functions, the images may also be arranged by number of “nices” from most to fewest with respect to the searched or limited categories.

In one embodiment, the server analyzes the total number of images for a given community wall display, taking into consideration any filters that may be applied, and maintains the ordering of the images based on the number of nices associated with each image. When the server receives a request to display a community wall, the images may be rendered in the then current-order. If the community wall page is refreshed (e.g., another display request is sent to the server), the server may then display the images in the newest current order, taking into consideration any additional nice indicators that have been received for the images between requests. The filters that may be applied to the community wall may be handled on the server side or the terminal side.

Image resolution for the images on a community wall may be maintained in their original resolution or modified such that the resolutions of each image match. Alternatively, the image resolution may be increased for images higher in position on the community board. Images may also receive badges or other indicators based on a number of nice indicators received for each image.

In an embodiment, the order of the images on a community board may also be determined by a freshness factor. The freshness factor may be based on the number of most recent nice indicators versus older nice indicators. In such embodiments, the more recent nice indicators are given a higher weight than older nice indicators, such that images with a larger number of recent nice indicators will be positioned higher than images with a larger number of older nice indicators. An alternate community board may be generated that displays the images in order regardless of freshness (e.g., a “hall of fame” board). In this way, a community board can be generated where older images do not reside at the top for an extended period of time with the freshness factor, but another community board can be generated which will display older photos at the top of the page.

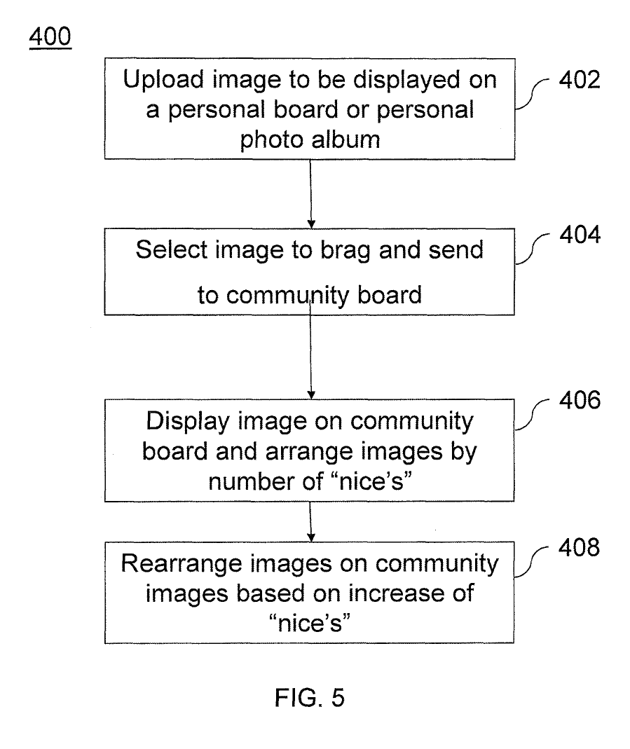

At FIG. 5, a flowchart 400 of steps for arranging a community board are shown according to aspects of the invention. At block 402, an image is uploaded to be displayed on a personal board/personal photo album. A user may upload an image directly to their personal board/personal photo album via a terminal with a software application, or upload an image to a server for the server to generate a personal board and serve the personal board to be displayed on a terminal as described above. Additionally, a user may provide additional data associated with the uploaded image, such as metadata, GPS coordinates, time and day, species of animal, etc. The server 106 may store and provide the user with options for selecting metadata to facilitate the user's selection of metadata for association with the image. In one embodiment, the server 106 provides the user with the option to select stored metadata, such as, outfitter related information, gear used, identity or who was their guide, GPS coordinates, weather information, animals spotted, and/or outfitter information as disclosed in U.S. Patent Publication No. 2014/0229851, which is incorporated in its entirety herein for all purposes.

At block 404, an image is selected to be “bragged” and sent to a community board. A user may select an image from the user's personal board or other location where the image is displayed by “bragging” the image (e.g., by utilizing a brag button). In examples where the image is uploaded to a server, the server receives the brag from the user. In examples where the image is uploaded directly to the terminal via a software application, selecting the image to “brag” operates to upload the image to the server and send the “brag” to the server. Once the user has bragged the image, the system may require the user to provide additional data associated with the image for the image to be sent to the community board. The “bragged” image and associated data may be sent via the user's terminal to a central server to be displayed on the community board.

At block 406, the “bragged” images are displayed on the community board when accessed by a user and the images are arranged by the number of “nices” received per image. A user may access the community wall via a terminal configured to display the community wall. In an embodiment, the community wall is displayed as a collage-like arrangement. The images on the community wall are arranged from top to bottom according to the number of “nices” associated with each image. Users viewing the community wall (or a personal page as described above) can select an image to “nice”, thereby sending the “nice” to a server and increasing the number of “nices” received for the image.

At block 408, the images on the community board are rearranged based on an increase in the number of “nices” associated with each image. When a user chooses to “nice” an image, the number of “nices” received for that image increases, and may result in the image being moved up on the community board. A processor may be configured to rearrange the images at predetermined time intervals, and/or in real time. In embodiments where the processor is configured to rearrange the images based on the number of “nices” in real time, the community wall may be configured to display the image moving to the new position. Thus, when a user “nices” an image, the user will see the image move up the community board physically while seeing other images (which would now have received fewer “nices”) physically move down the board or physically rearrange such that the order of the images on the community wall is properly rearranged according to the number of “nices” received for each image.

Additional functionality of the systems, methods, and devices described herein may be advantageously provided. For example, the community board may be configured to receive advertisements, images, or other sponsored posts from advertisers, such that these posts may remain at fixed locations on the community board. Advertisers may include outfitters or other companies whose brands are associated with the image. When a user selects to “brag” an image, the user may also include a story to go along with that image, which can be accessed and read by other users viewing the community board. Users may also be tagged in each image. Additionally, outfitters may have outfitter boards separate from the community board, and when an outfitter is associated with an image that is “bragged,” that image can appear on the outfitter's board. In one embodiment, the outfitters are prohibited from bragging their own images to ensure that the bragging is more genuine, coming from users rather than outfitters themselves. The outfitter's board may also indicate an image's ranking on various community boards.

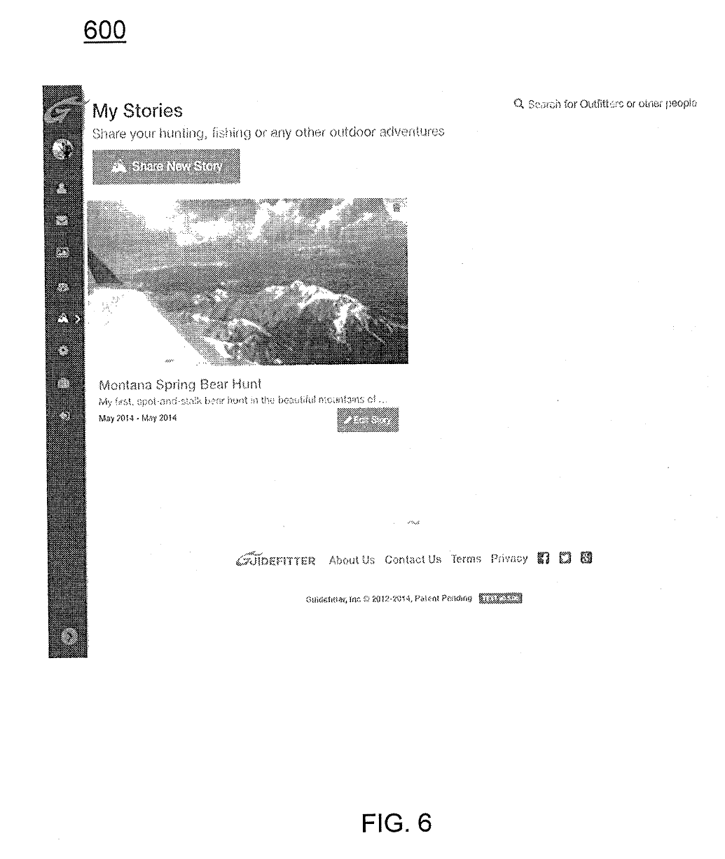

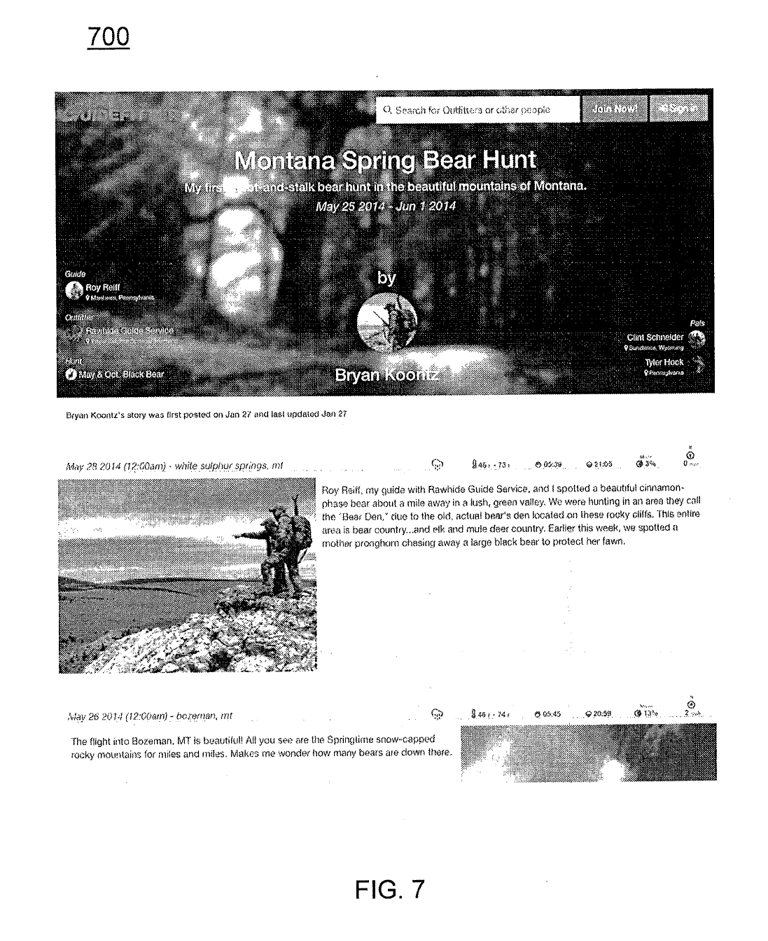

The systems may also implement story organization and story page creation/management, such as story page 600 at FIG. 6 and story page 700 at FIG. 7. Users may plan adventures or trips with other users utilizing the systems described above. For example, users may compare ideas, gear, stories, images, overall impressions, etc., and discuss aspects of the adventures, such as weather, elevation, etc. with other users. Stories may be set up by a user for other users to view and join. In an embodiment, the story is set up with a cover page (including a cover image, title of the story, description of the story, URL, dates, locations, environmental metadata, etc.) for other users to view via the personal boards or community boards. Users may create stories as standalone entries on their personal pages independent from bragging walls or community boards. The user may upload images and then add storyline information about the image and about what happened on their adventure. The stories may be sponsored by outfitters and linked via an ad on the community board or personal boards. Multiple users may bring content to an adventure page to share information and data, such as images, stories, etc. The adventures page may also include outfitter products and services offered or to be used during the adventures. The information and data from the users and/or outfitters may be added to the adventures pages from a terminal 100 to a server 106. The server 106 may store the data and information (e.g., via storage 108) and make the information and data available to other users.

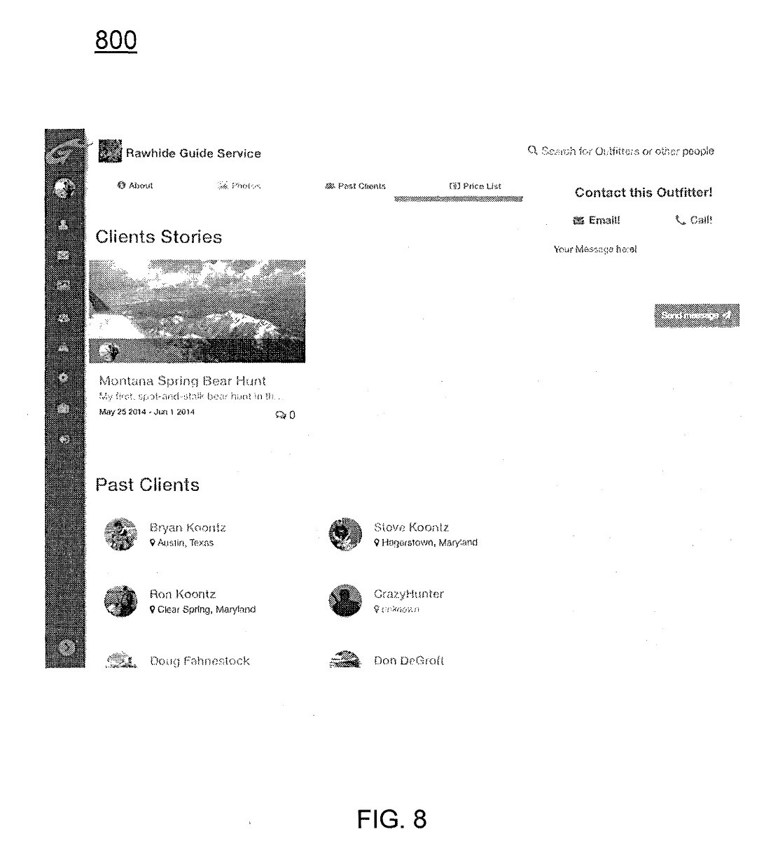

The system provides unique ways in which a user can tell others about an adventure they went on or are currently on in real time. The users may add images and other information regarding their adventure. For example, the information may include outfitter information, gear used, identity or who was their guide. In an embodiment, additional information may be pulled automatically from the Internet or their surroundings, such as weather information from online weather services, sea-level data, GPS coordinates from an image's EXIF information, etc. Stories may be shared among other users and multiple users may add information to each story page. Users may select to join a story page by sending a request (e.g., via a “join” button) to the user who created the story. The user who created the story page may permit other users to post on the story page and may manage the posts on the story page. In an embodiment, an outfitter can be tagged in a story. When tagged, the story may be accessible in a list of stories associated with the outfitter on the outfitter page, as is depicted in outfitter page 800 of FIG. 8. When viewing a story that includes a tagged outfitter, the story page may include a link that allows a user to contact the outfitter directly. Additionally, other users may be tagged in the stories, such that the story page is accessible via the user's personal board/photo album. In one embodiment, images associated with the story can receive brag indicators and nice indicators from the story page.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A computer architecture for displaying and arranging images, comprising:
a plurality of terminals coupled to a central server, each terminal configured to
display images provided by the central server, the images including personal images and non-personal images, the central server displaying at least a portion of the images in accordance with a layout;
receive brag indicators for personal images displayed by that terminal;
receive nice indicators for non-personal images displayed by that terminal; and
transmit brag indicators and nice indicators to the central server; and
the central server, the central server including a processor and a memory storage device, the processor configured to
receive the brag indicators and the nice indicators associated with the images from the plurality of terminals;
generate the layout based on the received brag indicators and the received nice indicators such that images are emphasized based on a number of nice indicators associated with the images; and
transmit the layout to the plurality of terminals for display of at least a portion of the images.

2. The computer architecture of claim 1, wherein the processor is further configured to regenerate the layout in response to changes in the number of nice indicators received from the plurality of terminals.

3. The computer architecture of claim 1, wherein the terminals include an interface for the user to send a nice indicator to the server for an image displayed on the layout, thereby increasing the number of nice indicators associated with the displayed image.

4. The computer architecture of claim 1, wherein the terminals display the images on the layout rearranging when the processor rearranges the layout.

5. The computer architecture of claim 1, wherein the at least one personal board is further configured to receive additional data associated with the images.

6. The computer architecture of claim 5, wherein the additional data includes at least one of animal species, outfitter, GPS data, date, time, or story.

7. The computer architecture of claim 1, wherein the processor is further configured to generate a community board including the bragged images having the generated layout for display on all of the plurality of terminals.

8. The computer architecture of claim 7, wherein each terminal is further configured to receive the personal images display on that terminal from a user of that terminal and wherein the processor is configured to generate a plurality of personal boards, each personal board associated with one of the plurality of terminals and including the personal images received by that terminal.

9. A method for displaying and arranging images, comprising:
receiving, from a terminal, a personal image to be displayed on at least one personal board;
receiving, from the terminal, a brag of the personal image to display the bragged personal image on a community board;
arranging, with a processor, bragged images displayed on the community board based on a number of nices received for each bragged image;
receiving, from the terminal, a nice for one of the bragged images displayed on the community board;
rearranging, with the processor, the images on the community board based on the change in the number of nices received for each of the bragged images displayed on the community board; and
displaying the rearranged images on the community board.

10. The method of claim 9, wherein the rearranging step is performed in real time.

11. The method of claim 9, wherein the rearranging of the images on the community board is visibly performed.

12. The method of claim 9, further comprising the step of receiving, at the terminal, additional data associated with the bragged images to be displayed on the community board.

13. The method of claim 12, further comprising limiting the images to be displayed on the community board based on the additional data.

14. The method of claim 9, wherein the arranging step is further based on at least one of elapsed time since each image was received or elapsed time since each image was bragged.
